(19) United States
(12) Patent Application Publication
(10) Pub. No.: US 2006/0111936 A1
(43) Pub. Date: May 25, 2006

(54) Container system and method for hosting healthcare applications and componentized archiecture

(75) Inventors: Prakash Mahesh, Schaumburg, IL (US); Mark Morita, Arlington Heights, IL (US); Steven L. Fors, Chicago, IL (US)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 10/996,237

(22) Filed: Nov. 23, 2004

(51) Int. Cl. G06Q 10/00; G06F 7/00

(52) U.S. Cl. 705/2; 707/3

(57) ABSTRACT

Certain embodiments of the present invention provide a method and system for improved medical workflow and interfacing in a healthcare environment using a unified interface framework. In an embodiment, the system includes a unified user interface allowing access to a plurality of medical components, wherein the unified user interface coordinates the plurality of medical components to provide unified access and display of information from the plurality of medical components. The system may also include a context manager, such as a rules-based context manager. The system may further include a plurality of perspectives for organizing the plurality of medical components and interactions within the unified user interface. One or more of the medical components may include a user interface accessible by the unified user interface, wherein the access is transparent to a user. The unified user interface may allow access to the plurality of medical components via a single sign-on.

### BACKGROUND OF THE INVENTION

The present invention generally relates to improved workflow in a healthcare environment. In particular, the present invention relates to use of a unified interface to improve workflow and synchronize application access in a healthcare environment.

A clinical or healthcare environment is a crowded, demanding environment that would benefit from organization and improved ease of use of imaging systems, data storage systems, and other equipment used in the healthcare environment. A healthcare environment, such as a hospital or clinic, encompasses a large array of professionals, patients, and equipment. Personnel in a healthcare facility must manage a plurality of patients, systems, and tasks to provide quality service to patients. Healthcare personnel may encounter many difficulties or obstacles in their workflow.

A variety of distractions in a clinical environment may frequently interrupt medical personnel or interfere with their job performance. Furthermore, workspaces, such as a radiology workspace, may become cluttered with a variety of monitors, data input devices, data storage devices, and communication device, for example. Cluttered workspaces may result in efficient workflow and service to clients, which may impact a patient's health and safety or result in liability for a healthcare facility. Data entry and access is also complicated in a typical healthcare facility.

Thus, management of multiple and disparate devices, positioned within an already crowded environment, that are used to perform daily tasks is difficult for medical or healthcare personnel. Additionally, a lack of interoperability between the devices increases delay and inconvenience associated with the use of multiple devices in a healthcare workflow. The use of multiple devices may also involve managing multiple logons within the same environment. A system and method for improving ease of use and interoperability between multiple devices in a healthcare environment would be highly desirable.

In a healthcare environment involving extensive interaction with a plurality of devices, such as keyboards, computer mousing devices, imaging probes, and surgical equipment, repetitive motion disorders often occur. A system and method that eliminate some of the repetitive motion and reduce repetitive motion injuries would be highly desirable.

Healthcare environments, such as hospitals or clinics, include clinical information systems, such as hospital information systems (HIS) and radiology information systems (RIS), and storage systems, such as picture archiving and communication systems (PACS). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during surgery, medical personnel may access patient information, such as images of a patient's anatomy, that are stored in a medical information system. Alternatively, medical personnel may enter new information, such as history, diagnostic, or treatment information, into a medical information system during an ongoing medical procedure.

Imaging systems are complicated to configure and to operate. Often, healthcare personnel may be trying to obtain an image of a patient, reference or update patient records or diagnosis, and ordering additional tests or consultation. Thus, there is a need for a system and method that facilitate operation and interoperability of an imaging system and related devices by an operator.

In many situations, an operator of an imaging system may experience difficulty when scanning a patient or other object using an imaging system console. For example, using an imaging system, such as an ultrasound imaging system, for upper and lower extremity exams, compression exams, carotid exams, neo-natal head exams, and portable exams may be difficult with a typical system control console. An operator may not be able to physically reach both the console and a location to be scanned. Additionally, an operator may not be able to adjust a patient being scanned and operate the system at the console simultaneously. An operator may be unable to reach a telephone or a computer terminal to access information or order tests or consultation. Providing an additional operator or assistant to assist with examination may increase cost of the examination and may produce errors or unusable data due to miscommunication between the operator and the assistant. Thus, a method and system that facilitate operation of an imaging system and related services by an individual operator would be highly desirable.

A reading, such as a radiology or cardiology procedure reading, is a process of a healthcare practitioner, such as a radiologist or a cardiologist, viewing digital images of a patient. The practitioner performs a diagnosis based on a content of the diagnostic images and reports on results electronically (e.g., using dictation or otherwise) or on paper. The practitioner, such as a radiologist or cardiologist, typically uses other tools to perform diagnosis. Some examples of other tools are prior and related prior (historical) exams and their results, laboratory exams (such as blood work), allergies, pathology results, medication, alerts, document images, and other tools. For example, a radiologist or cardiologist typically looks into other systems such as laboratory information, electronic medical records, and healthcare information when reading examination results.

Currently, a practitioner must log on to different systems and search for a patient to retrieve information from the system on that patient. For example, if a patient complains of chest pain, a chest x-ray is taken. Then the radiologist logs on to other systems to search for the patient and look for specific conditions and symptoms for the patient. Thus, the radiologist may be presented with a large amount of information to review.

Depending upon vendors and systems used by a practitioner, practitioners, such as radiologists or cardiologists, have only a few options to reference the tools available. First, a request for information from the available tools may be made in paper form. Second, a practitioner may use different applications, such as a radiologist information system (RIS), picture archiving and communication system (PACS), electronic medical record (EMR), healthcare information system (HIS), and laboratory information system (LIS), to search for patients and examine the information electronically.

In the first case, the practitioner shifts his or her focus away from a reading workstation to search and browse through the paper, which in most cases includes many pieces of paper per patient. This slows down the practitioner and introduces a potential for errors due to the sheer volume of paper. Thus, a system and method that reduce the amount of paper being viewed and arranged by a practitioner would be highly desirable.

In the second case, electronic information systems often do not communicate well across different systems. Therefore, the practitioner must log on to each system separately and search for the patients and exams on each system. Such a tedious task results in significant delays and potential errors. Thus, a system and method that improve communication and interaction between multiple electronic information systems would be highly desirable.

Additionally, even if systems are integrated using mechanisms such as Clinical Context Object Workgroup (CCOW) to provide a practitioner with a uniform patient context in several systems, the practitioner is still provided with too much information to browse through. Too much information from different applications is provided at the same time and slows down the reading and analysis process. There is a need to filter out application components that a user will not need in a routine workflow. Thus, a system and method that manage information provided by multiple systems would be highly desirable.

Furthermore, if a technologist is performing a radiology or cardiology procedure, for example, the technologist typically accesses multiple applications to obtain information prior to the procedure. In a digital environment, information resides in a plurality of disparate systems, such as a RIS and a PACS. Currently, the technologist must access each system and search for the information by clicking many tabs and buttons before having access to all of the information needed to start the procedure. Often, such an effort by a technologist to obtain information for a procedure results in a decrease in productivity due to the time involved and/or a decrease in information quality due to the time involved to do a thorough search. Thus, a system and method that improve searchability and access to data would be highly desirable.

Additionally, referring physicians use many computerized applications for patient care. In radiology, a physician may look at information from RIS, PACS, EMR, and Computer Physician Order Entry (CPOE), for example. The referring physician typically accesses multiple applications to get all of the information needed before, during and/or after the patient consult and follow-up. For example, in a digital environment, the referring doctor refers to a RIS for results from a current procedure, prior procedures, and/or a web-based image viewer, such as a PACS, for viewing any current and prior images. The doctor may access a CPOE to order any follow-up exams. The referring physician opens the RIS, PACS, and CPOE to search for the information by clicking many tabs and buttons before having access to the information. Thus, there is a need for a system and method that improve searchability and access to data.

Physicians and other healthcare professionals use many applications and modules. Typically, applications and modules use disparate interfaces and different formats. Applications may have separate logins, separate “look and feel”, have their own browsers, and include distinct user interfaces.

Thus, there is a need for a system and method to improve medical application workflow and interfacing in a healthcare environment.

### BRIEF SUMMARY OF THE INVENTION

Certain embodiments of the present invention provide a method and system for improved medical workflow and interfacing in a healthcare environment using a unified interface framework. In an embodiment, the system includes a unified user interface allowing access to a plurality of medical components, wherein the unified user interface coordinates the plurality of medical components to provide unified access and display of information from the plurality of medical components.

The system may also include a context manager, such as a rules-based context manager. The system may further include a plurality of perspectives for organizing the plurality of medical components within the unified user interface. In an embodiment, one or more of the medical components include a user interface accessible by the unified user interface, wherein the access is transparent to a user. The unified user interface may allow access to the plurality of medical components via a single sign-on, for example. The plurality of medical components may include application(s), information system(s), and/or data store(s), for example.

Certain embodiments of a method for providing access to a plurality of medical applications via a unified interface include providing a unified interface in communication with a plurality of applications, accepting a request for access to an application via the unified interface, automatically routing the request to the application, and returning a result from the application to the unified interface. The unified interface may then display the result in a predefined format or layout, for example. In an embodiment, the access includes execution of a function and/or retrieval of data, for example.

The unified interface may interact with individual interfaces for each of the plurality of applications and masks the individual interfaces. In an embodiment, the unified interface allows access to the plurality of applications via a single sign-on. The unified interface may provide a uniform appearance across the plurality of applications. In an embodiment, the plurality of applications and/or the result may be filtered based on one or more rules. The plurality of applications and/or result may be organized based on at least one perspective, for example.

In certain embodiments, a computer-readable storage medium includes a set of instructions for a computer. The set of instructions includes a user interface routine for hosting a plurality of components, wherein the user interface routine allowing a user to access the plurality of components using a single interface. The set of instructions also includes an information retrieval routine for forming an information query for at least one of the plurality of components based on input from the user interface routine. The user interface routine may interact with interfaces for the plurality of components, and the interaction may be transparent to a user. The set of instructions may also include a context management routine for defining a context coordinating a plurality of information sources. Additionally, the set of instructions may include a rules engine routine for defining rules for processing information. In an embodiment, the set of instructions includes a perspectives routine for organizing the information for a user.

### BRIEF DESCRIPTION OF SEVERAL VIEWS OF THE DRAWINGS

FIG. 1 illustrates a unified medical application interface system used in accordance with an embodiment of the present invention.

FIG. 2 illustrates a flow diagram for a method for improved interfacing and workflow using a unified user interface in accordance with an embodiment of the present invention.

FIG. 3 shows an example of a container used to host multiple applications and data used in accordance with an embodiment of the present invention.

FIG. 4 shows an example of a container used to host multiple applications and data used in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

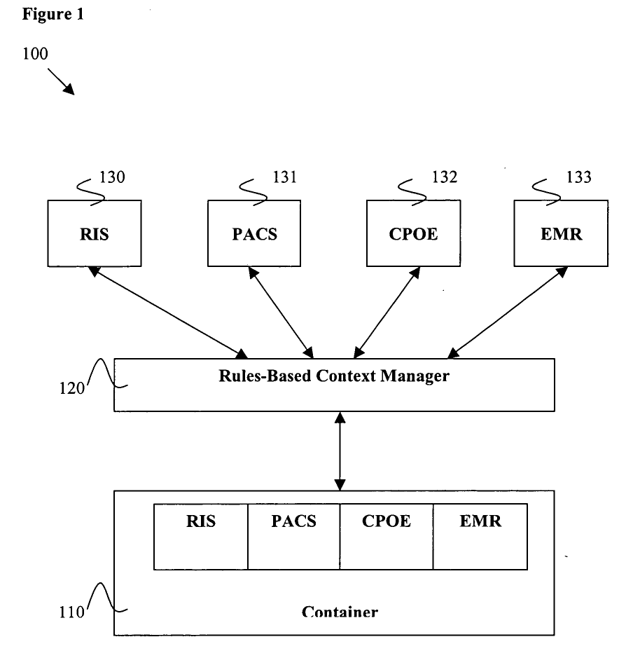

FIG. 1 illustrates a unified medical application interface system 100 used in accordance with an embodiment of the present invention. The system 100 includes a container or user interface 110, a context manager 120, and a plurality of information systems 130, 131, 132, 133. Information systems 130-133 may include a radiology information system (RIS) 130, a picture archiving and communication system (PACS) 131, Computer Physician Order Entry (CPOE) 132, an electronic medical record (EMR) 133, Clinical Information System (CIS), Cardiovascular Information System (CVIS), and/or Library Information System (LIS), for example. The context manager 120 may be a clinical context object workgroup (CCOW) context manager or other rules-based context manager, for example. The components of the system 100 may communicate via wired and/or wireless connections on one or more processing units, such as computers, medical systems, storage devices, custom processors, and/or other processing units. In an embodiment, the components of the system 100 are integrated into a single unit.

The system 100 may be used to provide an integrated solution for application execution and/or information retrieval based on rules and context sharing, for example. For example, context sharing allows information and/or configuration options/settings, for example, to be shared between system environments. Rules, for example, may be defined dynamically and/or loaded from a library to filter and/or process information generated from an information system and/or an application.

The context manager 120 may be used to create patient and/or examination context sharing between information systems 130-133. The context manager 120 may be an integrated or standalone software and/or hardware manager for context sharing between information systems 130-133. The manager 120 may also provide relevant information within a patient and/or examination context based on rules. The context manager 120 may be a context manager such as CCOW, which uses an HL7 standard to support user and patient context sharing, or other context management system. Context sharing allows information from a plurality of systems to be combined in a single context or setting. For example, information on a particular patient may be extracted from a RIS, a PACS, and an EMR. The manager 120 works in conjunction with the container 110 to extract information from systems 130-133 using extensible markup language (XML), simple object access protocol (SOAP), and/or other protocol, for example. The container 110 includes a user interface, such as a graphical or voice command user interface, to allow a user to access components and features of the system 100.

In an embodiment, the context manager 120 and/or container 110 includes and/or communicates with an authentication unit. The authentication unit may include software and/or hardware to verify a user's right to access one or more of the manager 120, information systems 130-133, and/or container 110. In an embodiment, authentication via the context manager 120 and/or container 110 allows access to relevant information systems 130-133 and other applications for a user. If a user logs on to a system running the context manager 120, a rule may be created and saved to log onto certain information systems 130-133 to access the user's preferred information.

For example, a physician may prefer to look at labs, allergies and medication. Thus, a rule is created to log on to an LIS and HIS for labs, allergies and medication when the physician logs onto the system 100. Applications, such as LIS and HIS, are moved to a correct patient context. Along with the context and based on rules, the LIS and HIS display pertinent information for a patient. For example, the applications display all lab results for the patient for a specific date. The applications also display all complete blood count (CBC) data for the patient for the date. As another example, rules may filter patient alert data for a specific date range and/or specific disease type. Thus, from the same workstation using the system 100, a user may look at a RIS for relevant prior reports, search a PACS for relevant prior images, and/or examine a LIS and/or HIS for specific information, all based on context sharing and rules. As a result, diagnosis and diagnostic reports may be reached more quickly and more accurately. In an embodiment, the container 110 automatically presents a user with most relevant and/or most desired information based on rules, preferences, and/or other settings without a search by the user.

Rules for the context manager 120 and/or container 110 may be created in a variety of ways. Rules may be generated automatically by a rules engine based on preset parameters and/or observed data, for example. Rules may also be created by a system administrator or other user. Rules may be changed to provide different information for diagnosis. Rules also may be manually and/or automatically adapted based on experiences.

A user may log on any one of the connected systems and access information found on all of the connected systems through context sharing and/or a unified user interface 110. The information may be filtered for easier, more effective viewing. Thus, a user may access desired information from a plurality of systems with unwanted information removed through a common user interface framework.

In operation, a user, such as a radiologist or cardiologist, accesses the container 110 via a RIS/PACS system, for example. RIS and PACS systems may be integrated into a single system, for example, with shared patient and exam contexts. Thus, the user access relevant prior history for a patient (e.g., images and reports). For example, the radiologist may log on to the RIS/PACS system which retrieves and integrates information from different systems based on an EMR number. Automatic login to one or more systems/applications may be accomplished via context management.

However, a large quantity of information may result from such context sharing. All of the information may be linked at the patient level, for example. The context manager 120 and container 110 provide relevant prior history and other information, for example, based on rules. Rules may be applied to images, reports, and other data.

Rules-based context management allows information to be provided to a practitioner for a patient based on certain rules. Rules may be used by a practitioner and/or system to define a context for information. For example, if a radiologist only wishes to see lab results for two months, a rule may be used to only provide the previous two months of lab results to the radiologist. Rules may be created based on time period, examination type, disease type, system type, etc. Rules may be predefined and/or created on the fly by the practitioner. Rules may also be automatically generated and/or modified by a rules engine based on practitioner usage patterns and/or preferences, for example.

For example, a referring physician preparing for a patient looks at a requested procedure, prior clinical conditions of the patient, protocols from a radiologist, and relevant prior images, current reports and current images. The container 110 and context manager 120 allow the physician to set up a rule for exams to provide procedure and report information from a RIS, clinical conditions from an EMR, protocols from the RIS, and current images and relevant prior images from a PACS, for example. When the physician meets with the patient, the rules engine 110 may trigger the context manager 120 with information that determines a context. The context is driven by the context manager 120 to connected applications and relayed to the physician's desktop. Thus, by selecting an exam, the referring physician sees a variety of information.

For example, a computed tomography (CT) technologist preparing to scan a patient reviews at a requested procedure, prior clinical conditions of the patient, protocols from a radiologist, and relevant prior images. The technologist may use the container 110 and context manager 120 to define a rule for CT exams to provide procedure information from a RIS, clinical conditions from an EMR, protocols from the RIS, and relevant prior images from a PACS. When the technologist selects to begin the procedure, the container 110 triggers the context manager 120 with information deciding the context for the exam. The context is driven by the context manager 120 to connected applications and related to the technologist's desktop to enable the technologist to have access to relevant information by selecting an exam.

In an embodiment, the manager 120 may work together with a perspectives management system for handling multiple applications and workflow. The perspectives management system allows various perspectives to be defined which save workflow steps and other information for a particular user. Perspectives may be used to save visual component positioning information and interactions based on workflow, for example. Perspectives allow relevant information to be presented to a user.

In an embodiment, a plurality of medical perspectives are software components that save visual component positioning and interactions between medical applications and/or information systems based on workflow. Medical application perspectives are a mechanism used to create a plurality of benefits for users of the system 100. For example, perspectives provide patient context sharing between different applications and components that a user views. Additionally, for example, perspectives provide an ability to switch between different configurations or perspectives based on which applications and components a user wishes to view at any given point. Furthermore, for example, perspectives provide an ability to store or “remember” specific workflow steps. Perspectives provide a mechanism to save and display information relevant to a particular user, group, and/or function, for example.

Perspectives that may be saved by and/or for one or more users. For example, a perspective may include viewing an exam worklist on a color monitor, one or more images displayed on one or more diagnostic monitors, and a report editor on the bottom of the color monitor. For example, another perspective may include viewing related prior report(s) on the color monitor, related prior image(s) on one diagnostic monitor, and current image(s) on another diagnostic monitor. For example, a perspective may show viewing all labs and allergies for a period of time (e.g., two months) for a patient on the color monitor and viewing current image(s) on the diagnostic monitor(s). As another example, a perspective may include viewing any maximum intensity projection/multiplanar reconstruction (MIP/MPR) image set for a current exam on a diagnostic monitor.

Perspectives may be used to logically group different applications. Rules, configuration options, and/or other criteria may be defined in order to define perspectives. Perspectives may be defined for images, examination results, laboratory data, patient history data, structured report data, DICOM data, and/or other data, for example. In an embodiment, perspectives do not eliminate or change information but rather order information in a certain way. For example, information important to a user may be displayed first, with additional information available via different perspectives. In an embodiment, the manager 120 and/or container 110 may “learn” through user selection or other configuration information, for example, to create perspectives automatically without manual intervention by the user.

The container 110 hosts or serves as a user interface for different applications, modules, and/or information systems, for example. The different components, such as the information systems 130-133, may be arranged by a user within the container 110 based on workflow perspectives and/or rules, for example. Data may be accessed through the container 110 from separate data stores, applications, and/or information systems. In an embodiment, data is routed to the container 110 by different components in a predefined data syntax. For example, data may be retrieved from a plurality of information systems 130-133 for use by the container interface 110.

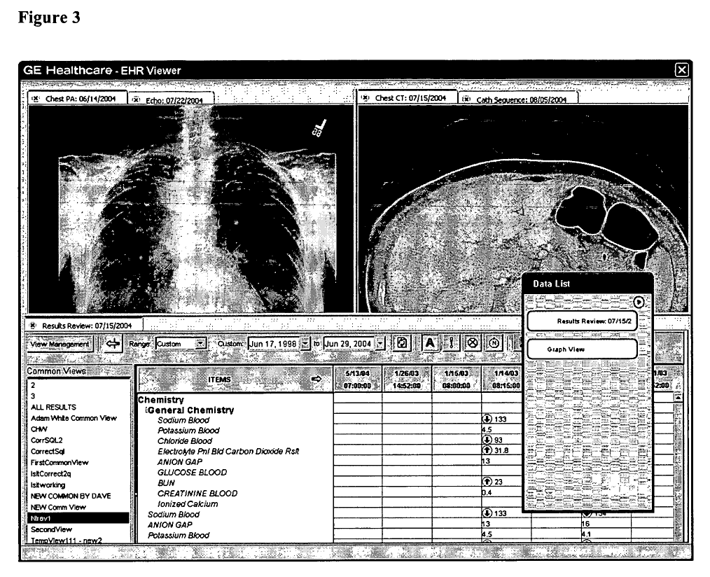

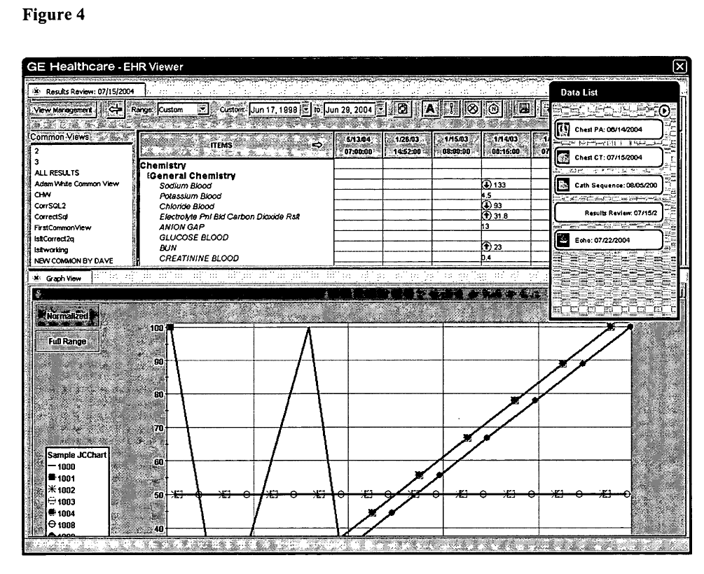

In an embodiment, the container 110 may be customized by selecting a “skin” or appearance from a plurality of options. The container 110 may be used to provide the same “look and feel” (e.g., buttons, menus, display) for all applications in the container 110. For example, a physician sees a same application feel across multiple medical applications. FIG. 3 shows an example of a container used to host multiple and disparate types of information. FIG. 4 depicts an example of a container displaying lab results and a graphing tool, for example. In an embodiment, the container 110 may arrange information, applications, and/or interactions in a certain layout and/or format. The layout and/or format may be customized based on user and/or system settings and/or preferences, for example.

For example, a radiologist accessing RIS, PACS, EMR and other clinical systems accesses one container with a selected skin. All application components are hosted within the container. Components are arranged with medical perspectives for specific workflows.

As another example, a referring physician accessing EMR, cardiology, radiology and CPOE systems accesses one container application. The physician logs on to the container interface application and is automatically logged on to the underlying systems. The physician accesses all of the modules and applications in one application feel.

The container 110 integrates a componentized architecture and multiple applications and/or information systems within a common framework. The container 110 provides a uniform user interface working in place of or on top of separate interfaces. A user may “sign on” or access multiple applications and/or systems via a single authentication or access point. In an embodiment, rather than providing separate windows for separate applications, one window is used to provide access to a plurality of applications. That is, multiple windows for multiple applications are hosted within the container 110. The container 110 may operate with or without the context manager 120.

For example, a radiologist is reviewing data for a patient to make a diagnosis. In addition to images, the radiologist reviews examination results historical information, and other patient information. The radiologist may access all of the information using the container 110. Rather than separately accessing and interacting with a plurality of systems to obtain the various forms of information, the radiologist simply accesses the container 110 and retrieves the desired information via the container 110. The radiologist may configure the container 110 to display information and/or components in a particular layout or configuration, for example. Using the container 110, the radiologist may access patent laboratory results, allergies, medications, discharge summary, operative notes, pathology report, images, and/or other patient information, for example. The container 110 hosts applications and/or data from PACS, RIS, HIS, CIS, CVIS, LIS, and/or other information system, imaging system or data source for access by the user.

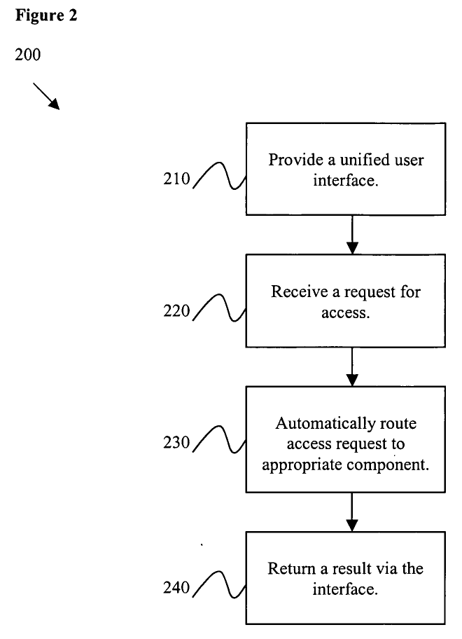

FIG. 2 illustrates a flow diagram for a method 200 for unified interfacing with a plurality of applications used in accordance with an embodiment of the present invention. First, at step 210, a unified user interface is provided for a user. The unified user interface is in communication with one or more applications and/or information systems, for example. The unified user interface interacts with individual interfaces for the application(s) and/or system(s) and masks or hides the individual interfaces from a user. That is, the user sees and interacts with the unified user interface rather than the underlying individual interfaces. A user may be authenticated at the unified user interface. Authentication at the unified user interface may propagate through the connected application(s) and/or system(s), for example.

At step 220, a request for access is received at the unified user interface. For example, a user requests patient information from a RIS via the unified interface. Then, at step 230, the request is automatically routed to the appropriate application and/or information system. For example, the interface contacts or queries the RIS or RIS interface to request application execution and/or data retrieval, for example. In an embodiment, context sharing may be used to obtain information from a plurality of sources.

At step 240, a result is returned from the application to the unified interface. In an embodiment, the result is returned in a predefined layout according to user or system preferences. The result may be an application execution and/or retrieved information, for example. In an embodiment, the result may be filtered and/or formatted by one or more rules defined by the system and/or a user, for example. In an embodiment, result(s), application(s), and/or other components may be organized for display via the unified user interface using one or more perspectives.

In certain embodiments, a unified user interface may be implemented using a set of instructions on a computer-readable storage medium, such as a PACS workstation or other computing system. The set of instructions includes a user interface routine for hosting a plurality of components. The user interface routine allows a user to access the plurality of components through a single interface. The set of instructions also includes an information retrieval routine for forming an information query for at least one of the plurality of components based on input from the user interface routine. The user interface routine may interact with individual interfaces for the plurality of components. The interaction between the user interface routine and individual component interfaces (e.g., individual interface routines) may be transparent to a user. For example, a user requests data and executes applications via the user interface routine on a universal workstation and does not see or directly interact with the individual user interfaces for the components supplying the data and applications. The set of instructions may also include a context management routine for defining a context coordinating a plurality of information sources. Additionally, the set of instructions may include a rules engine routine for defining rules for processing information. In an embodiment, the set of instructions includes a perspectives routine for organizing the information for a user.

Thus, certain embodiments provide a common container or interface framework to host a variety of components, such as applications, information systems, and other modules. Certain embodiments provide a single sign-on and access point for entering and retrieving data and executing applications. Certain embodiments improve workflow by providing a single container with a uniform look and feel and an ability to organize components and results using rules-based context management and perspectives. A single interface with a uniform look and feel may decrease training time and improve effectiveness and ease of use with a plurality of disparate systems.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A system for facilitating improved workflow and access to a plurality of medical components, said framework comprising:
a unified user interface allowing access to a plurality of medical components, wherein said unified user interface coordinates said plurality of medical components to provide unified access and display of information from said plurality of medical components.

2. The system of claim 1, further comprising a context manager.

3. The system of claim 2, wherein said context manager comprises a rules-based context manager.

4. The system of claim 1, further comprising a plurality of perspectives for organizing said plurality of medical components within said unified user interface.

5. The system of claim 1, wherein one or more of said plurality of medical components includes a user interface accessible by said unified user interface and wherein said access is transparent to a user.

6. The system of claim 1, wherein said unified user interface allows access to said plurality of medical components via a single sign-on.

7. The system of claim 1, wherein said plurality of medical components comprises at least one of applications, information systems and data stores.

8. A method for providing access to a plurality of medical applications via a unified interface, said method comprising:
providing a unified interface in communication with a plurality of applications;
accepting a request for access to an application via said unified interface;
automatically routing said request to said application; and
returning a result from said application to said unified interface in a predefined format.

9. The method of claim 8, wherein said access comprises at least one of execution of a function and retrieval of data.

10. The method of claim 8, wherein said unified interface interacts with individual interfaces for each of said plurality of applications and masks said individual interfaces.

11. The method of claim 8, wherein said unified interface allows access to said plurality of applications via a single sign-on.

13. The method of claim 8, wherein at least one of said plurality of applications and said result is filtered based on at least one rule.

14. The method of claim 8, wherein at least one of said plurality of applications and said result is organized based on at least one perspective.

15. The method of claim 8, wherein said unified interface provides a uniform appearance across said plurality of applications.

16. A computer-readable storage medium including a set of instructions for a computer, the set of instructions comprising:
a user interface routine for hosting a plurality of components, said user interface routine allowing a user to access said plurality of components using a single interface;
an information retrieval routine for forming an information query for at least one of said plurality of components based on input from said user interface routine.

17. The set of instructions of claim 16, wherein said user interface routine interacts with interfaces for said plurality of components and wherein said interaction is transparent to a user.

18. The set of instructions of claim 16, further comprising a context management routine for defining a context coordinating a plurality of information sources.

19. The set of instructions of claim 16, further comprising a rules engine routine for defining rules for processing information.

20. The set of instructions of claim 16, further comprising a perspectives routine for organizing the information for a user.
